(19) United States
(12) Patent Application Publication
(10) Pub. No.: US 2025/0368108 A1
(43) Pub. Date: Dec. 4, 2025

(54) PNEUMATIC VEHICLE SEAT

(71) Applicants: HYUNDAI MOTOR COMPANY, Seoul (KR); KIA CORPORATION, Seoul (KR); DAYOU A-TECH CO., LTD., Gwangju (KR); Daechang Seat Co.,LTD-Dongtan, Hwaseong-si (KR)

(72) Inventors: Ji Sun Lee, Hwaseong-si (KR); Jung Sang You, Hwaseong-si (KR); Ye Jin Seo, Hwaseong-si (KR); Jun Yong Kim, Hwaseong-si (KR); Kwang Woong Joo, Yongin-si (KR); Dong Jin Choi, Gunpo-si (KR); Dae Keon Jang, Hwaseong-si (KR); Ji Sung Bae, Seongnam-si (KR); Gun Young Park, Incheon (KR); Mu Hyun An, Osan-si (KR)

(73) Assignees: HYUNDAI MOTOR COMPANY, Seoul (KR); KIA CORPORATION, Seoul (KR); DAYOU A-TECH CO., LTD., Gwangju (KR); Daechang Seat Co.,LTD-Dongtan, Hwaseong-si (KR)

(21) Appl. No.: 18/922,081

(22) Filed: Oct. 21, 2024

(30) Foreign Application Priority Data
May 28, 2024 (KR) 10-2024-0068993

(51) Int. Cl. B60N 2/64; B60N 2/02

(52) U.S. Cl. CPC B60N 2/64; B60N 2/0224

(57) ABSTRACT

A pneumatic vehicle seat includes: a plurality of main air cells mounted above a seat cushion frame, a bolster air cell mounted above either lateral end of the seat cushion frame, a seat cushion pad laminated over the main air cells and the bolster air cell, a seat cover covering the seat cushion pad, and an air pump to selectively supply air to at least one of the main air cells and the bolster air cell. The air pump can selectively draw air from at least one of the main air cells and the bolster air cell.

### CROSS REFERENCE TO RELATED APPLICATION

This application claims priority to Korean Patent Application No. 10-2024-0068993, filed on May 28, 2024, the entire contents of which are incorporated herein by reference.

### BACKGROUND

### Technical Field

The present disclosure relates to a pneumatic vehicle seat and, more particularly, to a pneumatic vehicle seat having a seat cushion equipped with a plurality of air cells to enhance seating comfort.

### Description of the Related Art

In general, a vehicle seat includes a seat cushion on which the lower body is seated, a seatback on which the upper body is supported, and a headrest on which the neck and head of an occupant are supported. Various seat positioning devices and convenience devices may be installed inside or outside the seat.

The seat cushion has a structure where bolsters protrude on both sides to surround and support the lateral portions of the occupant's lower body. Similarly, the seatback has a structure where bolsters protrude on both sides to surround and support the lateral portions of the occupant's upper body.

Furthermore, the seat cushion is inclined upwardly at a predetermined set angle from the rear end to the front end to provide comfortable seating support to the occupant's lower body, and the seatback is angularly adjustable with respect to the seat cushion and foldable with respect to an upper surface of the seat cushion.

However, the above-mentioned conventional seat cushion has the following problems.

First, despite the fact that the seat cushion is made in a form in which the seat cushion is inclined upwardly at a predetermined set angle from the rear end to the front end, there is a problem that the seat cushion's seating support for the occupant's lower body is reduced due to the trend of flattening the seat cushion.

Second, there is a problem that the volumes of the bolsters surrounding the occupant's lower body decrease due to the trend of flattening the seat cushion, resulting in a decrease in support for the occupant's lower body.

Third, there is a drawback that it is not possible to adjust the height and cushioning of the localized area of the seat cushion desired by the occupant.

Fourth, despite the trend of flattening the seat cushion, the seat cushion is made in a structure in which the seat cushion is inclined upwardly at less than a predetermined set angle from the rear end to the front end, with bolsters formed on both sides, causing a problem that upon folding toward the upper surface of the seat cushion, the seatback may not be arranged in a flat position.

In other words, upon folding the seatback of the second-row seat over the seat cushion for securing a loading space in addition to the luggage compartment, the seatback needs to be arranged in a completely flat position so that the back surface of the seatback is flush with the floor surface of the luggage compartment. However, the upper surface of the seat cushion which is inclined upwardly from the rear end to the front end and the bolsters protruding from both sides of the seat cushion act as a contact interference factor when the seatback is folded, so that the seatback may not be arranged in a completely flat position upon the folding of the seatback over the upper surface of the seat cushion.

### SUMMARY

The present disclosure has been made in an effort to solve the above-described problems associated with the related art, and an objective of the present disclosure is to provide a pneumatic vehicle seat in which a plurality of air cells is arranged in the interior of a seat cushion so that the air cells may be adjusted in degree of inflation to provide the seat cushion with optimal seating comfort depending on the occupant's physical condition or preference. In particular, upon folding the seatback, the air cells in the seat cushion may also be deflated to allow the seatback to be arranged in a completely flat position over the seat cushion.

In an aspect of the present disclosure, a pneumatic vehicle seat includes: a plurality of main air cells mounted above a seat cushion frame; at least one bolster air cell mounted above either lateral end of the seat cushion frame; and a seat cushion pad laminated over the plurality of main air cells and the at least one bolster air cell. The pneumatic vehicle seat further includes: a seat cover covering the seat cushion pad; and an air pump configured to selectively supply air to at least one of the plurality of main air cells or the at least one bolster air cell, and configured to selectively draw air from at least one of the plurality of main air cells or the at least one bolster air cell.

The pneumatic vehicle seat may further include: a switch operated to regulate a volume of inflation of the plurality of main air cells and the at least one bolster air cell; and upon receiving a signal from the switch to drive the air pump, an air cell controller configured to operate the air pump to either supply air to or draw air from at least one of the plurality of main air cells or the at least one bolster air cell.

The air pump and the air cell controller may be mounted on an undersurface of the seat cushion frame.

A main hose may be connected between an outlet port of the air pump and an inlet port of the air cell controller, and a plurality of distribution hoses may be connected to an outlet port of the air cell controller, the plurality of main air cells and the at least one bolster air cell.

The plurality of main air cells may include: a front horizontal air cell arranged in a horizontal direction at the front side of the seat cushion frame; a middle horizontal air cell arranged in the horizontal direction at the middle side of the seat cushion frame; and a rear horizontal air cell arranged in the horizontal direction at the rear side of the seat cushion frame.

A main air cell of the plurality of main air cells may have a structure having a first upper air cell and a second lower air cell stacked on one another in a fluid-communicating manner.

The at least one bolster air cell may be arranged along a longitudinal direction above the lateral side of the seat cushion frame, and the at least one bolster air cell may have a structure having a first upper bolster air cell and a second lower bolster air cell stacked on one another in a fluid-communicating manner.

The seat cushion pad may be provided on an undersurface thereof with an upwardly recessed accommodating space where the plurality of main air cells and the at least one bolster air cell are placed.

The pneumatic vehicle seat may further include a support bar attached to a front end and both lateral ends of an undersurface of the seat cushion pad.

The support bar may include: a front horizontal bar attached to the undersurface of the seat cushion pad at the front end, extending along the horizontal direction; a pair of lateral longitudinal bars attached to the undersurface of the seat cushion pad at the both lateral ends, extending rearwardly from both lateral ends of the front horizontal bar along a longitudinal direction; and a pair of hinge parts integrally formed at rear ends of the lateral longitudinal bars and configured to hinge-connected to the seat cushion frame.

In one embodiment, a support groove, into which the support bar is inserted, formed across the undersurface of the seat cushion pad, along the front end and the both lateral ends of the undersurface.

The pair of lateral longitudinal bars may be provided on an undersurface thereof with a guide bar at a predetermined position, and the seat cushion frame may be provided with a guide hole through which the guide bar passes, such that the guide bar is configured to guide the up and down movement of the support bar.

The present disclosure provides the following effects by the aforementioned configurations to solve the problems.

First, the plurality of main air cells and the bolster air cells are arranged in the interior of the seat cushion so that the main air cells and the bolster air cells are individually adjusted in degree of inflation, thereby allowing for adjustment of the height and cushioning of the localized area desired by the occupant in the entire seat cushion and therefore providing the seat cushion with optimal seating comfort depending on the occupant's physical condition or preference.

Second, upon folding of the seatback, the inflated air cells in the seat cushion are individually deflated so that the upper surface of the seat cushion is lowered, thereby allowing the seatback to be easily arranged on the seat cushion in a completely flat position without any interference.

Third, upon folding of the seatback, the seatback is arranged on the seat cushion in the completely flat position so that the back surface of the seatback is flush with the floor surface of the luggage compartment, thereby easily securing the back surface of the seatback as an accommodation space, in addition to the luggage compartment.

Fourth, upon the occupant's sitting on or rising from the vehicle seat, the inflated bolsters are deflated, so that the occupant can conveniently sit on or rise from the vehicle seat without interference with the bolsters.

### BRIEF DESCRIPTION OF THE DRAWINGS

FIGS. 1A and 1B are exploded perspective views illustrating a pneumatic vehicle seat according to an embodiment of the present disclosure;

FIG. 2 is a side cross-sectional view illustrating the pneumatic vehicle seat according to an embodiment of the present disclosure;

FIG. 3 is a front cross-sectional view illustrating the pneumatic vehicle seat according to an embodiment of the present disclosure;

FIG. 4 is a side cross-sectional view illustrating an example of adjusting the seat cushion height of the pneumatic vehicle seat according to an embodiment of the present disclosure;

FIG. 5 is a side cross-sectional view illustrating an example of the operation of the pneumatic vehicle seat when the seatback is folded, according to an embodiment of the present disclosure; and

FIG. 6 is a front cross-sectional view illustrating an example of the operation of the pneumatic vehicle seat when the occupant sits down or rises from the seat, according to an embodiment of the present disclosure.

### DETAILED DESCRIPTION

Specific structural or functional descriptions presented in the embodiments of the present disclosure are only exemplified for the purpose of describing embodiments according to the concept of the present disclosure, which may be carried out in various forms. Further, the present disclosure should not be interpreted as being limited to the embodiments described herein, and should be understood as including all modifications, equivalents, and substitutes included in the ideas and technical scope of the present disclosure.

In the present disclosure, although terms such as first and/or second may be used to describe various components, the components are not limited to the terms. The terms are used only for the purpose of distinguishing one component from other components. For example, a first component may be referred to as a second component, and similarly, the second component may also be referred to as the first component, without departing from the scope according to the concept of the present disclosure.

Throughout the present disclosure, the same reference numerals refer to the same elements. Meanwhile, the terms used herein are for the purpose of describing embodiments and are not intended to limit the present disclosure. In the present disclosure, the singular form also includes the plural form unless otherwise specified in the phrase. Terms “comprises” and/or “comprising” used herein mean that the mentioned component, step, operation, and/or element does not exclude the presence or the addition of one or more other components, steps, operations, and/or elements.

When a component, device, element, or the like of the present disclosure is described as having a purpose or performing an operation, function, or the like, the component, device, or element should be considered herein as being “configured to” meet that purpose or to perform that operation or function.

Hereinafter, some embodiments of the present disclosure are described in detail with reference to the accompanying drawings.

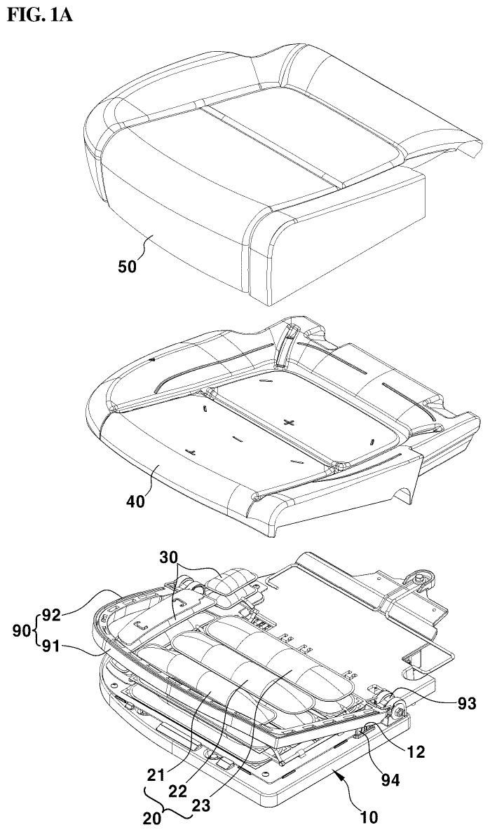

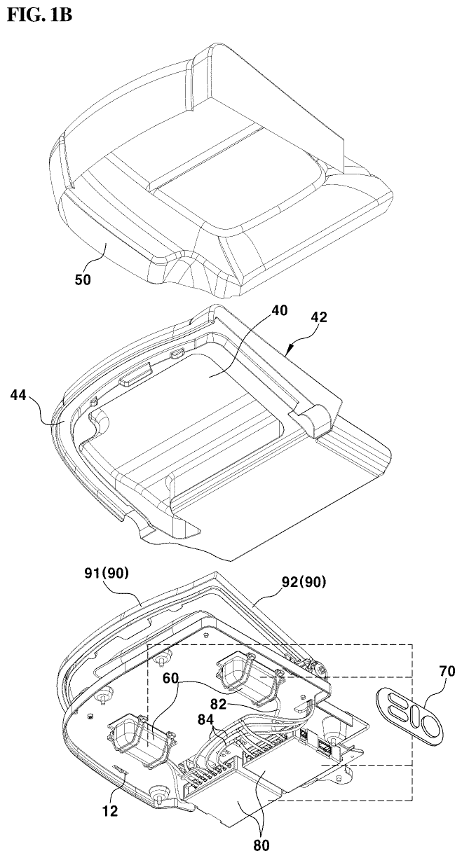

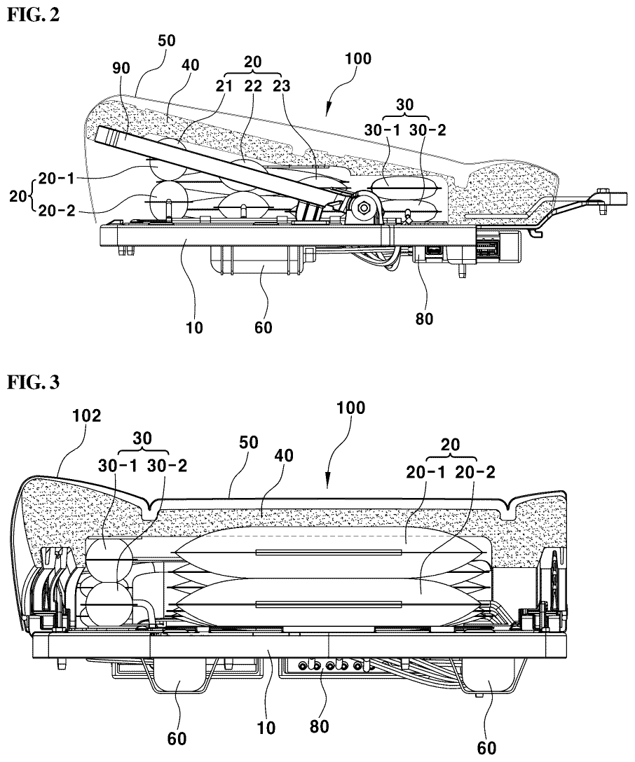

FIGS. 1A and 1B are exploded perspective views illustrating a pneumatic vehicle seat according to an embodiment of the present disclosure, and FIGS. 2 and 3 are cross-sectional views illustrating an assembled state of the pneumatic vehicle seat according to an embodiment of the present disclosure.

The seat cushion of the front seat, which is a stand-alone seat, is made of a structure having bolsters formed at both lateral ends, and the seat cushion 100 of the rear seat, which is a second-row seat, is made of a structure having a bolster 102 formed at each of both lateral ends adjacent to the rear doors, as illustrated in FIG. 3.

As illustrated in FIGS. 1B and 2, a plurality of main air cells 20 is mounted in a predetermined arrangement on the upper surface of a seat cushion frame 10, which is a seat cushion framework of the rear seat.

The main air cells 20 are designed to support the occupant's hips and thighs together with a seat cushion pad 40. In one embodiment, the main air cells 20 may include a total of three air cells: a front horizontal air cell 21, a middle horizontal air cell 22, and a rear horizontal air cell 23.

The front horizontal air cell 21 is mounted on the front side of the seat cushion frame 10 along a horizontal direction of the seat cushion frame 10, the middle horizontal air cell 22 is mounted on the middle side of the seat cushion frame 10 along the horizontal direction of the seat cushion frame 10, and the rear horizontal air cell 23 is mounted on the rear side of the seat cushion frame 10 along the horizontal direction of the seat cushion frame 10.

In one embodiment, the main air cells 20 may be configured in a structure that includes: a first upper air cell 20-1 and a second lower air cell 20-2, which are stacked on one another, along the vertical direction, in a fluid-communicating manner as illustrated in FIGS. 2 and 3, in order to easily secure vertical inflation (inflation height) for adjusting the height of the seat cushion.

A bolster air cell 30 is mounted on either lateral end of the seat cushion frame 10 in a manner that allows inflation and deflation so that the bolster air cell 30 is arranged along the longitudinal direction of the seat cushion frame 10 on either lateral end of the seat cushion frame 10.

In one embodiment, the bolster air cell 30 may be configured in a structure that includes: a first upper bolster air cell 30-1 and a second lower bolster air cell 30-2, which are stacked on one another, along the vertical direction, in a fluid-communicating manner as illustrated in FIGS. 2 and 3, in order to easily secure vertical inflation (inflation height) for adjusting the height of the bolster 102.

In one form, a seat cushion pad 40 having a predetermined shape is stacked on top of the plurality of main air cells 20 and the bolster air cell 20 mounted on the seat cushion frame 10, and the seat cushion pad 40 is covered with a seat cover 50.

At this time, the seat cushion pad 40 may be provided on an undersurface thereof with an upwardly recessed accommodating space 42 into which the upper portions of the main air cells and the bolster air cell are inserted and placed.

Accordingly, since the upper portion of each main air cell 20 and the upper portion of the bolster air cell 20 are inserted and seated within the accommodating space 42, the seat cushion pad 40 may be stably raised when the main air cell 20 and the bolster air cell 20 are inflated.

In another embodiment of the present disclosure, the pneumatic seat includes an air pump 60, a switch 70, and an air cell controller 80.

In an embodiment, at least two air pumps 60 and at least two air cell controllers 80 may be mounted on the undersurface of the seat cushion frame 10 as illustrated in FIG. 1B, and the switch 70 may be mounted on the lateral side of the seat cushion such that the occupant may directly operate the switch.

The air pump 60 is configured to selectively supply air to one or more selected air cells of the main air cells 20 and the bolster air cells 30, or to draw air from one or more selected air cells of the main air cells 20 and the bolster air cells 30.

The switch 70 is a switch for regulating a volume of air inflation for the selected air cells of the main air cells 20 and the bolster air cells 30. The switch 70 may include a combination of a plurality of buttons or levers operable directly by the occupant.

The air cell controller 80 may be a type of air distributor which is configured to allow a flow of air to be supplied to at least one of the main air cells 20 and the bolster air cells 30 upon receiving a signal from the switch 70 to drive the air pump 60 to supply air, or to allow a flow of air to be drawn from at least one of the main air cells 20 and the bolster air cells 30 upon receiving a signal from the switch to drive the air pump 60 to draw air.

In one embodiment, an air-supplying or air-drawing main hose 82 may be connected between an outlet port of the air pump 60 and an inlet port of the air cell controller 80, and a plurality of air-supplying or air-drawing distribution hoses 84 may be connected to an outlet port of the air cell controller 80, with distal ends thereof connected to the main air cells 20 and the bolster air cells 30.

In another embodiment, a plurality of branched air paths (not shown) may be formed inside the air cell controller 80 to direct air supplied from the main hose 82 to the distribution hoses 84, and a plurality of solenoid valves (not shown), which operate to open and close in response to an operating signal from the switch 70, may be internally installed at the points where the air paths or the outlet ports of the air cell controller 80 and the plurality of distribution hoses are connected.

Therefore, when all of the solenoid valves are opened and at the same time, the air pump 60 is driven to supply air, according to the operation of the switch 70, the air supplied from the air pump 60 passes sequentially through the main hose 82, the air paths of the air cell controller 80, and the distribution hoses 84 to the main air cells 20 and the bolster air cells 30, so that the main air cells 20 and the bolster air cells 30 may be inflated.

As described above, the main air cell 20 may include a first upper air cell 20-1 and a second lower air cell 20-2 stacked on one another, and the bolster air cell 30 may also include a first upper air cell 30-1 and a second lower air cell 30-2 stacked on one another, so that the main air cell 20 and the bolster air cell 30 may be easily inflated vertically.

When all of the solenoid valves are opened and at the same time, the air pump 60 is driven to draw air, according to the operation of the switch 70, the air in the main air cells 20 and the bolster air cells 30 passes sequentially through the distribution hoses 84, the air paths of the air cell controller 80, and the main hose 82 toward the air pump 60, so that the main air cells 20 and the bolster air cells 30 may be deflated.

In another embodiment, a support bar 90 is attached to an undersurface of the seat cushion pad 40 at the front end and both lateral ends to hold the seat cushion pad 40 from swaying side to side and at the same time, guiding the up-down movement direction of the seat cushion pad 40 to be constant, when the seat cushion pad 40 is moved up or down as the main air cells 20 and the bolster air cells 30 are inflated or deflated. In other words, the support bar 90 prevents the seat cushion pad 40 from swaying side to side when it is raised or lowered during the inflation or deflation of the main air cells 20 and the bolster air cells 30, while also guiding the seat cushion pad 40 in a consistent vertical direction.

To this end, the support bar 90 may include: a front horizontal bar 91 attached to the undersurface of the seat cushion pad 40 at the front end, a pair of lateral longitudinal bars 92 attached to the undersurface of the seat cushion pad 40 at the both lateral ends, extending rearwardly from both lateral ends of the front horizontal bar 91, and a pair of hinge parts 93 integrally formed at rear ends of the lateral longitudinal bars 92 and hinge-connected to the seat cushion frame 10, as illustrated in FIGS. 1A and 2.

In this case, the front horizontal bar 91 of the support bar 90 is attached to the undersurface of the front end of the seat cushion pad 40 along the horizontal direction, and the lateral longitudinal bars 92 are attached to the undersurface of the both lateral ends of the seat cushion pad 40 along the longitudinal direction.

In one embodiment, the seat cushion pad 40 is provided, on the undersurface of the front end and the both lateral ends, with a support groove 44 into which the support bar 90 is inserted placed. In other words, the support groove 44 is formed across the undersurface of the seat cushion pad, along the front end and the both lateral ends of the undersurface.

As such, by allowing the front horizontal bar 91 and the lateral longitudinal bars 92 of the support bar 90 to be inserted and engaged in the support groove 44 of the seat cushion pad 40, the support bar 90 may more stably hold the seat cushion pad 40 against swaying side to side, and may more consistently guide the up-down movement direction of the seat cushion pad 40.

Further, the lateral longitudinal bar 92 may be provided on an undersurface thereof with a downwardly protruding guide bar 94 at a predetermined position, and the seat cushion frame 10 may be provided with a guide hole 12 through which the guide bar 94 passes, such that the guide bar 94 can guide an up and down movement or a pivotal trajectory of the support bar 90.

Accordingly, when the seat cushion pad 40 is moved up or down as the main air cells 20 and the bolster air cells 30 are inflated or deflated, the support bar 90 may be pivotally moved together while being inserted into the support groove 44 to avoid or prevent the seat cushion pad 40 from swaying side to side, and as the guide bar 94 formed on the lateral longitudinal bar 92 of the support bar 90 passes through the guide hole 12 formed in the seat cushion frame 10, the support bar 90 may guide the up-down movement of the seat cushion pad 40 in a consistent direction.

Here, an example of the operation of the pneumatic seat of the present disclosure with the above configuration is described below.

When the plurality of solenoid valves are selectively opened and at the same time, the air pump 60 operates to supply air according to the operation of the switch 70, air supplied from the air pump 60 may be supplied to one or more selected air cells of the main air cells 20 and the bolster air cells 30 sequentially through the main hose 82, the air paths of the air cell controller 80, and the distribution hoses 84, so that the selected air cells of the main air cells 20 and the bolster air cells 30 may be inflated.

For example, as illustrated in FIG. 2, when the front horizontal air cell 21 of the main air cell 20 is inflated to its maximum inflation in the vertical direction, and the middle horizontal air cell 22 is inflated to a level lower than the front horizontal air cell 21, and the rear horizontal air cell 23 is inflated to a level lower than the front horizontal air cell 21, the inflation of each of the air cells 21, 22, and 23 causes the seat cushion pad 40 to be pushed upwardly, so that the seat cushion pad 40 may be arranged to be inclined upwardly at a predetermined angle from the rear end toward the front end.

At this time, because the front horizontal bar 91 and the lateral longitudinal bars 92 of the support bar 90 are inserted and fastened into the support groove 44 of the seat cushion pad 40, the front horizontal bar 91 and the lateral longitudinal bars 92 may pivot together during the elevation of the seat cushion pad 40 and stably hold the seat cushion pad 40 without causing the seat cushion pad 40 to sway or deform from side to side.

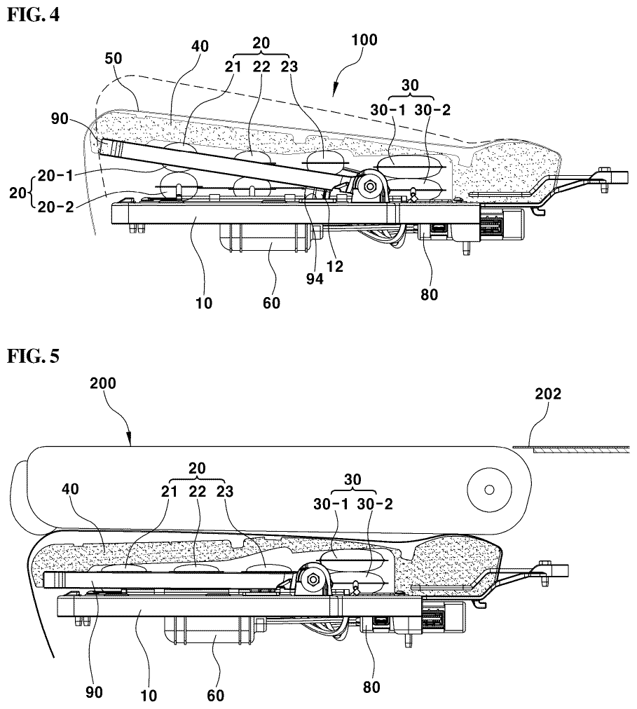

Alternatively, when the front horizontal air cell 21, the middle horizontal air cell 22, and the rear horizontal air cell 23 of the main air cell 20 are inflated to have approximately the same height, as illustrated in FIG. 4, the front end and the rear end of the seat cushion pad 40 may be deformed to approximately the same height, thereby flattening the seat cushion pad 40.

As such, the individualized inflation of the plurality of main air cells 20 allows for height and cushioning adjustments to be made to localized areas of the seat cushion desired by the occupant, and thereby provides the seat cushion with optimal seating comfort depending on the occupant's physical condition or preference.

FIG. 5 is a side cross-sectional view illustrating an example of the operation of a pneumatic vehicle seat when the seatback is folded, according to an embodiment of the present disclosure.

When the seatback 200 is folded and the switch 70 operates to open all of the plurality of solenoid valves and simultaneously drive the air pump 60 to draw air, air in the plurality of main air cells 20 and the bolster air cells 30 is supplied sequentially through the respective distribution hoses 84, the air paths of the air cell controller 80, and the main hose 82 toward the air pump 60, so that the main air cells 20 and the bolster air cells 30 may be deflated, as illustrated in FIG. 5.

Here, when the main air cell 20 and the bolster air cell 30 are deflated, the seat cushion pad 40 is lowered and the support bar 90 is pivoted downwardly about the hinge parts 93.

In this way, the air in each of the air cells 20, 30 in the seat cushion is discharged before folding the seatback 200 so that each of the air cells 20, 30 may be deflated, and the upper surface height of the seat cushion 100 is lowered by lowering the seat cushion pad 40.

In this state, when the seatback 200 is folded over the seat cushion 100, the seatback 200 may be easily folded over the seat cushion 100 in a completely flat position without any interference.

Thus, the seatback 200 is arranged on the seat cushion 100 in the completely flat position so that the back surface of the seatback 200 is flush with the floor surface 202 of the luggage compartment, thereby easily securing the back surface of the seatback as an accommodation space, in addition to the luggage compartment.

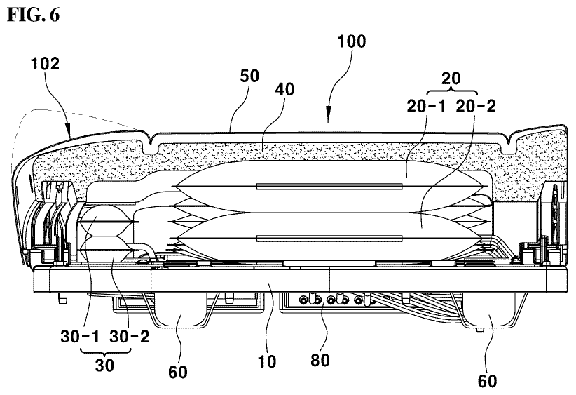

FIG. 6 is a front cross-sectional view illustrating an example of the operation of a pneumatic vehicle seat when the occupant sits down or rises from the seat, according to an embodiment of the present disclosure.

Considering that the occupant's lower body may be caught in the bolsters 102 of the seat cushion 100 while the occupant is sitting on or rising from the seat, which may cause discomfort, the inflated bolsters 102 of the seat cushion 100 are deflated, so that the occupant can conveniently get in or off without interference.

To this end, when the switch 70 is operated to open all of the plurality of solenoid valves associated with the bolster air cells 30 and simultaneously drive the air pump 60 to draw air, air is discharged toward the air pump 60 sequentially through the distribution hoses 84, the air paths of the air cell controller 80, and the main hose 82 which are associated with the bolster air cells 30, so that the bolster air cells 30 and therefore the bolsters 102 of the seat cushion 100 may be deflated, as illustrated in FIG. 6.

In this way, upon the occupant's sitting on or rising from the vehicle seat, the inflated bolsters 102 of the seat cushion 100 are deflated, so that the occupant can conveniently get in or off without interference.

While the present disclosure has been described in detail with reference to various embodiments, the scope of the present disclosure is not limited to the embodiments described above, and it should be understood that various modifications and improvements by those having ordinary skill in the art utilizing the basic concepts of the present disclosure as defined by the following patent claims are also included in the scope of the present disclosure.

What is claimed is:

1. A pneumatic vehicle seat comprising:
a plurality of main air cells mounted above a seat cushion frame;
at least one bolster air cell mounted above either lateral end of the seat cushion frame;
a seat cushion pad laminated over the plurality of main air cells and the at least one bolster air cell;
a seat cover covering the seat cushion pad; and
an air pump configured to selectively supply air to at least one of the plurality of main air cells or the at least one bolster air cell, and configured to selectively draw air from at least one of the plurality of main air cells or the at least one bolster air cell.

2. The pneumatic vehicle seat of claim 1, further comprising:
a switch operated to regulate a volume of inflation of the plurality of main air cells and the at least one bolster air cell; and
upon receiving a signal from the switch to drive the air pump, an air cell controller configured to operate the air pump to either supply air to or draw air from at least one of the plurality of main air cells or the at least one bolster air cell.

3. The pneumatic vehicle seat of claim 2, wherein the air pump and the air cell controller are mounted on an undersurface of the seat cushion frame.

4. The pneumatic vehicle seat of claim 2, wherein a main hose is connected between an outlet port of the air pump and an inlet port of the air cell controller, and a plurality of distribution hoses are connected to an outlet port of the air cell controller, the plurality of main air cells and the at least one bolster air cell.

5. The pneumatic vehicle seat of claim 1, wherein the plurality of main air cells comprises:
a front horizontal air cell arranged in a horizontal direction at a front side of the seat cushion frame;
a middle horizontal air cell arranged in the horizontal direction at a middle side of the seat cushion frame; and
a rear horizontal air cell arranged in the horizontal direction at a rear side of the seat cushion frame.

6. The pneumatic vehicle seat of claim 1, wherein a main air cell of the plurality of main air cells has a structure having a first upper air cell and a second lower air cell stacked on one another in a fluid-communicating manner.

7. The pneumatic vehicle seat of claim 1, wherein the at least one bolster air cell is arranged along a longitudinal direction above the lateral side of the seat cushion frame, and the at least one bolster air cell has a structure having a first upper bolster air cell and a second lower bolster air cell stacked on one another in a fluid-communicating manner.

8. The pneumatic vehicle seat of claim 1, wherein the seat cushion pad is provided on an undersurface thereof with an upwardly recessed accommodating space where the plurality of main air cells and the at least one bolster air cell are placed.

9. The pneumatic vehicle seat of claim 1, further comprising a support bar attached to a front end and both lateral ends of an undersurface of the seat cushion pad.

10. The pneumatic vehicle seat of claim 9, wherein the support bar comprises:
a front horizontal bar attached to the undersurface of the seat cushion pad at the front end, extending along a horizontal direction;
a pair of lateral longitudinal bars attached to the undersurface of the seat cushion pad at the both lateral ends, extending rearwardly from both lateral ends of the front horizontal bar along a longitudinal direction; and
a pair of hinge parts integrally formed at rear ends of the pair of lateral longitudinal bars and configured to be hinge-connected to the seat cushion frame.

11. The pneumatic vehicle seat of claim 10, wherein a support groove, into which the support bar is inserted, formed across the undersurface of the seat cushion pad, along the front end and the both lateral ends of the undersurface.

12. The pneumatic vehicle seat of claim 10, wherein the pair of lateral longitudinal bars is provided on an undersurface thereof with a guide bar at a predetermined position, and the seat cushion frame is provided with a guide hole through which the guide bar passes, such that the guide bar is configured to guide an up and down movement of the support bar.
